(19) United States
(12) Patent Application Publication
(10) Pub. No.: US 2014/0196024 A1
(43) Pub. Date: Jul. 10, 2014

(54) SYSTEMS AND METHODS FOR FIRMWARE DISTRIBUTION AND UPDATE OVER REMOTE APPLICATION

(71) Applicant: Nfuzion Inc., Fayetteville, GA (US)

(72) Inventors: David Kristian Hanon, Dayton, VA (US); Gareth Williams, Ann Arbor, MI (US); Randy Tyner, Greer, SC (US)

(73) Assignee: Nfuzion Inc., Fayetteville, GA (US)

(21) Appl. No.: 14/149,319

(22) Filed: Jan. 7, 2014

Related U.S. Application Data
(60) Provisional application No. 61/749,709, filed on Jan. 7, 2013.

(51) Int. Cl. G06F 9/445

(52) U.S. Cl. CPC G06F 8/65
USPC 717/178

(57) ABSTRACT

Described herein are firmware update systems and methods for providing a update/upgrade path for a plurality of products. An exemplary firmware update system may comprise Application Store providing applications to commonly available consumer devices like cell phones, tables and/or laptops, whose application provides a method of carrying with it a payload of firmware that can be distributed to a plurality of products. An exemplary integration system may or may not also comprise a central or remote database that tracks and manages the status of the Target Devices. An exemplary integration system may or may not also comprise a Target Device that can in turn communicate with other Target Devices within its realm of communication to provide a firmware update to these Secondary Target Devices.

### CROSS REFERENCE TO RELATED APPLICATION

This application claims benefit under 35 U.S.C. §119(e) of U.S. Provisional Patent Application No. 61/749,709, filed Jan. 7, 2013, and entitled “Systems and Methods for Firmware Distribution and Update Over Remote Applications”, which is incorporated herein by reference as if set forth herein in its entirety.

### TECHNICAL FIELD

Various embodiments of the invention relate to integration systems for a plurality of distinct products and, more particularly, to systems and methods for updating firmware in embedded systems that do not have access to update servers.

### BACKGROUND

As products are increasing in complexity, many products are being asked to do more as new technology is developed. To extend a product's capabilities the firmware within the embedded system needs to be updated to allow the product to do more. Many of these products, however, do not have a simple way to update the firmware. Many of these products require specialized equipment and or software making the upgrading of the product time consuming and costly. Further, the management and tracking of firmware version and status is becoming increasingly important to the product supplier or manager.

### SUMMARY

Some or all of the above needs may be addressed by certain implementations of the disclosed technology. According to an example implementation, a method is provided. The method includes, receiving, at a carrier device, an application carrying a firmware payload comprising one or more firmware packages associated with one or more of a plurality of target devices, wherein the carrier device is connectable to one or more of the target devices. Further, the method includes determining, with a computer processor, that a first target device in communication with the carrier device is associated with a first firmware package in the firmware payload. The method further includes transferring the firmware package to the first target device after the determination that the first target device is associated with the first firmware package and receiving a status from the first target device regarding installation of the first firmware package on the first target device. According to the example implementation, the method further includes determining, with a computer processor, that a secondary target device in communication with the first target device is associated with a second firmware package in the firmware payload. The method further includes directing the first target device to transfer the second firmware package to the secondary target device and receiving a status from the first target device regarding installation of the second firmware package on the secondary target device.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary process by which a carrier device acquires an application.

FIG. 2 illustrates an exemplary process by which a carrier device updates the firmware of a target device.

FIG. 3 illustrates an exemplary process by which a carrier device updates one or more secondary target devices via an intermediary device.

FIG. 4 illustrates an exemplary process by which a carrier device exchanges information with an update server.

FIG. 5 illustrates an exemplary process by which an application distribution system notifies a carrier device of an available application update.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Definitions/Glossary

Application: a software product that is easily obtainable, updatable and removable from a consumer electronics system.

Application Distribution System: a repository of applications for specific devices and/or operating systems that provide access to a user for installation of new, updating existing and/or maintaining their device. Alternatively referred to as an “application store” or “app store.”

Carrier Device: a commercially available device, e.g., a cell phone, tablet, or laptop computer, that communicates with a Target Device and, upon a determination that a Target Device requires an update, transports an update to the Target Device.

Firmware: a portion or complete software that is intended to be operated within an embedded system.

Target Device: a device or system that is earmarked for an update.

Update: an update process that replaces an earlier version of all or part of a software system with a newer release.

Update Server: a device or system that authors and initiates an update.

### Overview

To facilitate an understanding of the principles and features of embodiments of the invention, various illustrative embodiments are explained below. Although exemplary embodiments of the invention are explained in detail, other embodiments are contemplated. Further, in describing the exemplary embodiments, specific terminology will be resorted to for the sake of clarity. It is not intended that the invention is limited in its scope to the details of construction and arrangement of components set forth in the following description or illustrated in the drawings. The invention is capable of other embodiments and of being practiced or carried out in various ways.

An exemplary embodiment of the firmware update system may update multiple systems within a product through the use of one application carrying firmware payloads to the product (hereafter referred to as a Target Device). The process/methodology would begin by user/technician choosing a commercially available device like a cell phone, tablet or laptop (hereafter referred to as a Carrier Device). They would then select an application from their appropriate application store (hereafter referred to as the App Store). The application would carry with it a software/firmware payload that it could then deliver to an embedded system within the Target Device. The user/technician would then connect the Carrier Device to the Target Device via a wired or wireless connection. The Carrier Device would negotiate with the Target Device to determine if it needs a firmware update. The Target Device may also communicate to other Target Devices that it is connected to (hereafter referred to as Secondary Target Devices) to determine if any of these systems also need a firmware update. Once the Target Devices have determined if the firmware provided as a payload from the Carrier Device's application is needed, it will then receive the firmware update and communicate their status back to the Carrier Device. The Carrier Device will then be disconnected from the Target Device. Once the Carrier Device can communicate with the internet, it will communicate the status of the Target devices back to the Update Server or other Cloud Repository as designated by the Target Device manager or designer. When the Target Device manager or developer wishes to update the Target Device, an updated application with a new payload is uploaded to the App Store. The App Store will then send a push notification to the Carrier Device notifying it to update the payload carrying application on the Carrier Device. From here, the Carrier Device can once again be used to further update the Target Devices.

For purpose of example and without limitation, various devices may be referred to as Devices A, B, or C. Generally, Device A could be any portable electronic device which has the ability to install, execute, and update applications from available application distribution networks such as, for example, application stores. Device B could be any electronics product that has the ability to connect, either wirelessly or via a wired connection, to a Device A. Device B typically has the ability to negotiate, update, and execute its own applications. Generally, Device C could be any electronics product that has the ability to connect, either wirelessly or via a wired connection, to a Device B, which typically acts as a gateway device, as will be explained in further detail below. Typically, Device C has the ability to negotiate, update, or have its applications updated such that it can then execute its applications.

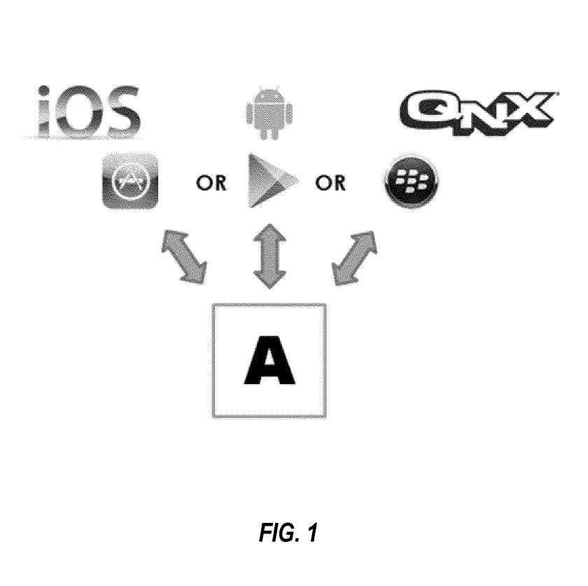

Referring now to FIG. 1, an exemplary process by which a carrier device acquires an application is illustrated. According to one embodiment, Device A (i.e., the carrier device) downloads an application that is published by or on the behalf of the developer of Device B (i.e., target device). Typically, the application is developed specifically with the ability to carry a firmware payload, negotiate with, and update Device B. In one embodiment, Device A registers, downloads, and installs this application from an application distribution system (i.e., app store).

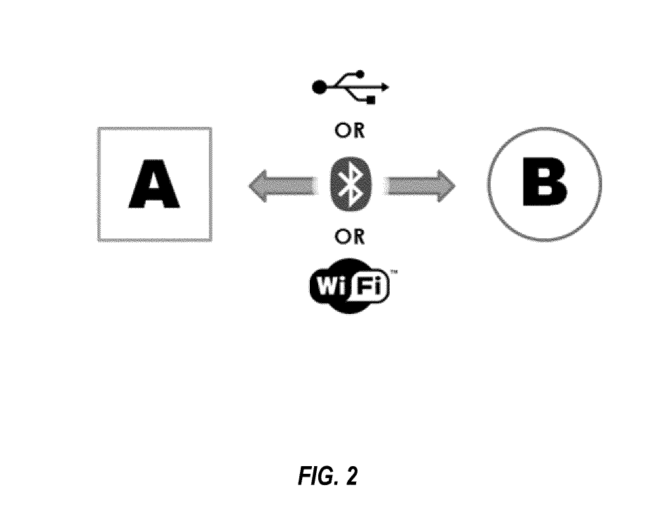

Referring now to FIG. 2, an exemplary process is illustrated by which a carrier device updates the firmware of a target device. In one embodiment, a user brings Device A within the proximity of Device B and then connects the two devices either wirelessly (e.g., via WiFi or Bluetooth connection) or via a wired connection (e.g., USB connection). Typically, Device A communicates and negotiates with Device B and establishes whether the firmware of Device B needs to be updated. If there is a newer firmware payload within the Device A application, Device B typically is updated. Generally, Device B is updated without notifying the user or without intervention from the user. Typically, once the firmware is updated, the devices disconnect and Device A application retains the status and update information of Device B, which can be sent to the publisher of the application once internet connectivity is available.

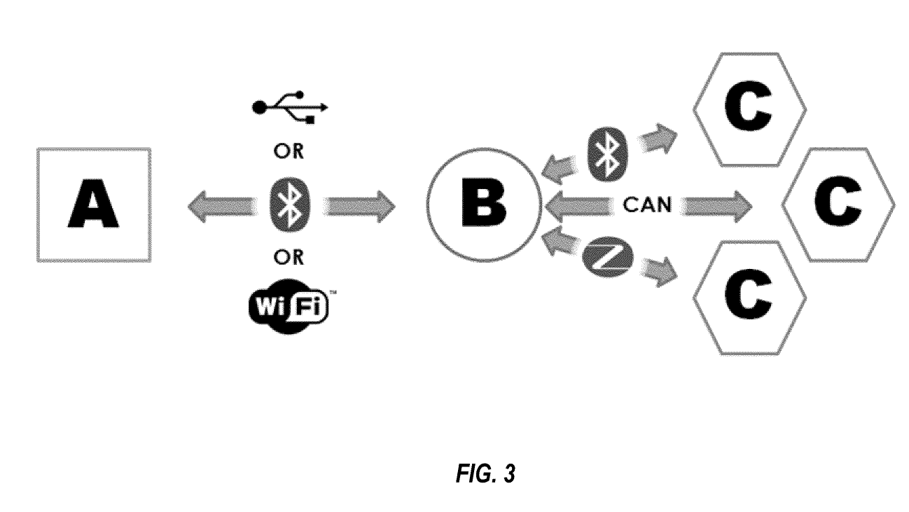

Referring now to FIG. 3, an exemplary process by which a carrier device updates one or more secondary target devices is illustrated. According to one embodiment, a user brings Device A within the proximity of Device B such that the devices can establish a connection either wirelessly or via a wired connection. Generally, Device A communicates and negotiates with Device B and establishes whether the firmware of Device C requires an update. Typically, Device B acts as an update gateway for downstream type-C devices that may have limitations for communicating with Device A. In one embodiment, Device A passes the upgrade payload to Device B, which then updates the downstream type-C devices. Generally, Device B then reports to Device A an updated status relating to the type-C, which Device A generally uploads to the publisher of the application once internet connectivity is available.

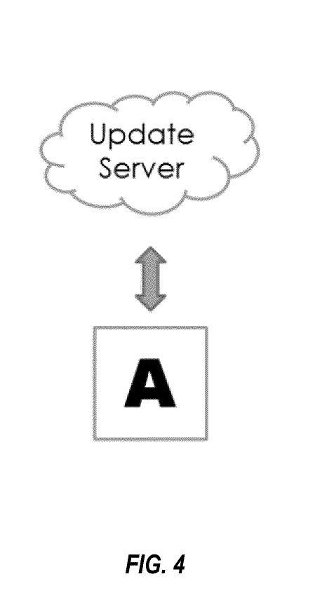

Referring now to FIG. 4, an exemplary process is illustrated by which a carrier device exchanges information with an update server. According to one embodiment, Device A establishes connection with a cloud-based server to upload an update status of target devices B and C. The update server may download new update payloads based on user interaction or without user interaction. Depending on the published application, the user may be able to select types of updates, diagnostics, and personalization of custom features of the target devices.

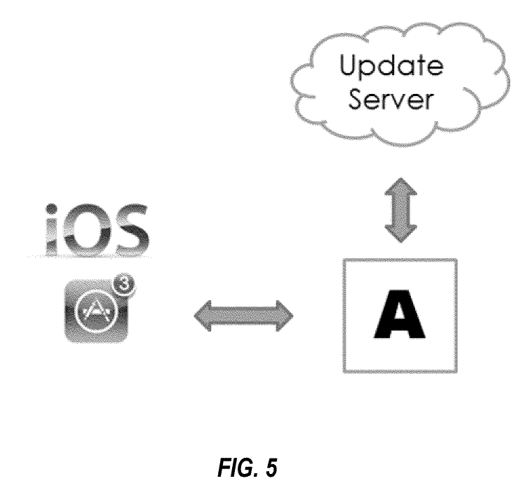

Referring now to FIG. 5, an exemplary process by which an application store notifies users of an update is illustrated. According to one embodiment, Device A establishes a connection with a specific application distribution system (i.e., app store), which may then push an update notification to the device if there is an update to the published application. In one embodiment, this notification could be triggered based on an update for the target devices or used to update the local application for Device A. In one embodiment, the payload for future updates for target devices can either be sent to Device A by direct communication to an Update Server or through an application distribution system.

In one embodiment, for example, a carrier device acquires an update application, updates a single requisite target device, and then exchanges update information with an update server. Alternatively, in one embodiment, a carrier device may update a plurality of target devices. For example, a carrier device may acquire an update application and then update designated devices B and C. Subsequently, the carrier device exchanges update information relating to devices B and C with an update server.

In one example, a carrier device may acquire an update application and then update various target devices. After updating the target devices, the carrier devices then exchanges update information with an update server. Subsequently, when there are new updates for the target devices, the carrier device is notified, either via a respective application distribution system or via direct push notification, that updates are available for the target devices. Typically, the carrier device then updates the target devices and exchanges update information with an update server.

In certain instances, it may be necessary to partially update a target device. According to one embodiment, a carrier device acquires an update application. A user is then presented with update options that allow the user to determine which components the user desires to update (e.g., languages, databases, other personalization, etc.). Alternatively, the update application may be directed with a secure script based on services purchased by the user, which determines what components will be updated. Accordingly, the carrier device updates the target device and then exchanges update information with an update server.

### A. Further Exemplary Uses of Certain Embodiments

For example, the firmware update system may be associated, and in communication with, a car or other vehicle. The user/technician has downloaded an application from his/her App Store on to his Carrier Device. Because the vehicle does not have an internet connection it does not have access to the updated firmware for its different systems. The user/technician brings their chosen Carrier Device with the payload application to the vehicle. The user/technician could attach their device via a USB connection to the head unit in the vehicle (Target Device). The head unit will negotiate a connection with the Carrier Device. The application on the Carrier Device will then communicate the firmware payloads it has available to the head unit. From here it will be determined if any of these payloads are required by the head unit. Should one be determined to be needed by the head unit, the head unit will receive the payload and update its firmware. It will then communicate to the Carrier Device that it has received the firmware upgrade and also communicate any other status messages required to the Carrier Device.

The head unit would then look at other systems that it is connected to in the vehicle like for example the rear seat entertainment system. The rear seat entertainment system may not have a USB interface but it is connected to the head unit. The head unit will then communicate to the rear seat entertainment system to determine if a firmware upgrade is available for the rear seat entertainment system and if it is, deliver that firmware to the rear seat entertainment system. Once updated, the updated status from the rear seat entertainment system would be communicated back to the head unit and from there onto the Carrier Device.

Once the head unit has determined that no other Target Devices need any further firmware payloads from the Carrier Devices application, the Target Device and the Carrier Device will be disconnected.

Once the Carrier Device is able to communicate with the internet, the Target Device(s) status will be communicated to the Update Server or any other repository designated by the Target System's developer or manager.

### B. Design Considerations for Certain Embodiments

Below are some considerations that may be made while developing an embodiment of the integration system. It will be understood that not all considerations may apply to every embodiment of the invention, and considerations not provided below may also be applicable.

The firmware update designer will need to consider the allowable payload size by the different Carrier Devices they consider for their update system. Some firmware updates such as the map data for a navigation system within a vehicle could be quite large. The designer would need to consider any limitations to the application size as well as how quickly the Carrier Device can deliver that payload to the Target Device.

The firmware update designer will also need to consider the different methods the Carrier Device can deliver the payload. These include both wired and wireless connections. Different Carrier Devices will have different specifics on how they communicate through these avenues. Care must be taken to develop a strategy that can be leverage across different Carrier Devices with different operating systems and different App Stores to make the update system as accessible as possible.

The designer must also take care to develop a database management system to be able to track and manage all devices under their care. The timing associated with when Target Devices get updated could be very scattered based on how often and how accessible the Target Devices are to the user/technician's presence.

### C. Benefits of Certain Embodiments

An exemplary embodiment of the present invention addresses some challenges presented by the need to add functionality and or improvements to existing devices as well as track the status of devices that do not have direct access to an update server.

An exemplary firmware update system of the present invention provides for multiple systems within a product to have their embedded firmware updated through a single commonly available Carrier Device without having to interact with each system with specialized equipment and or software.

The above example is for a vehicle, but a gateway and methodology may similarly be used in another environment where multiple products are used. For example, a home is another place where one might need to update the firmware on multiple systems. For example a whole home entertainment system with a media server could have several embedded systems that we would want to update the firmware on. These embedded systems within the entertainment system could include an amplifier, control panels, media interfaces and many other products. By connecting to one of the devices within the system (Target Device) with our Carrier Device, this multitude of embedded systems could receive firmware updates.

While the firmware update system has been disclosed in exemplary forms, it will be apparent to those skilled in the art that many modifications, additions, and deletions may be made without departing from the spirit and scope of the system, method, and their equivalents, as set forth in claims to be filed in a later non-provisional patent application.

What is claimed is:

1. A computer-implemented method comprising:
receiving, at a carrier device, an application carrying a firmware payload comprising one or more firmware packages associated with one or more of a plurality of target devices, wherein the carrier device is connectable to one or more of the target devices;
determining, with a computer processor, that a first target device in communication with the carrier device is associated with a first firmware package in the firmware payload;
transferring the firmware package to the first target device after the determination that the first target device is associated with the first firmware package;
receiving a status from the first target device regarding installation of the first firmware package on the first target device;
determining, with a computer processor, that a secondary target device in communication with the first target device is associated with a second firmware package in the firmware payload;
directing the first target device to transfer the second firmware package to the secondary target device; and
receiving a status from the first target device regarding installation of the second firmware package on the secondary target device.
